(19) United States
(12) Patent Application Publication
(10) Pub. No.: US 2026/0261816 A1
(43) Pub. Date: Sep. 3, 2026

(54) Apparatus, Methods and Computer Programs for Generating Spatial Audio Output

(71) Applicant: Nokia Technologies Oy, Espoo (FI)

(72) Inventors: Sujeet Shyamsundar MATE, Tampere (FI); Jussi Artturi LEPPANEN, Tampere (FI); Arto Juhani LEHTINIEMI, Lempaala (FI)

(21) Appl. No.: 18/718,253

(22) PCT Filed: Nov. 25, 2022
(86) PCT No.: PCT/FI2022/050787

§ 371 Date: Jun. 10, 2024

(30) Foreign Application Priority Data
Dec. 22, 2021 (GB) 2118740.6

(51) Int. Cl. H04S 7/00

(52) U.S. Cl. CPC H04S 7/304; H04S 2400/11; H04S 2420/11

(57) ABSTRACT

Examples of the disclosure can be used to generate spatial audio in situations where there are a plurality of sound sources (103) in a large listening space or in which a plurality of sources (103) can be distributed within a plurality of different listening spaces. Examples of the disclosure can enable a user (107) to listen to sources in a listening position (111) different to the current position (109) of the user (107). This could enable the user (107) to hear sound sources (103) that are far away and/or located in a different listening space.

### TECHNOLOGICAL FIELD

Examples of the disclosure relate to apparatus, methods and computer programs for generating spatial audio outputs. Some relate to apparatus, methods and computer programs for generating spatial audio outputs from audio scenes comprising a plurality of sources.

### BACKGROUND

Spatial audio enables spatial properties of a sound scene to be reproduced for a user so that the user can perceive the spatial properties. This can provide an immersive audio experience for a user or could be used for other applications.

### BRIEF SUMMARY

According to various, but not necessarily all, examples of the disclosure there is provided an apparatus for generating spatial audio output, the apparatus comprising means for:
obtaining spatial audio parameters for a position of a user;
obtaining spatial audio parameters for a listening position, different to the position of the user;
rendering the spatial audio for the position of the user;
rendering the spatial audio for the listening position;
mapping the spatial audio parameters for the listening position into a zone that corresponds to the position of the user; and
merging the spatial audio for the position of the user with the spatial audio for the listening position to enable the spatial audio for the position of the user to be played back simultaneously with the spatial audio for the listening position.

The listening position may comprise a zoom position.

The means may be for adapting the spatial audio parameters for the zoom position to take into account the position of the user relative to the zoom position.

The means may be for re-mapping the spatial audio parameters to a reduced zone to take into account the position of the user relative to the listening position.

The size of the reduced zone may be determined by the distance between the position of the user and the listening position.

The reduced zone may be configured to reduce rendering of sounds positioned between the position of the user and the listening position.

An angular position of the reduced zone may be determined based on an axis connecting the listening position and the position of the user.

The position of the user and the zoom position may be comprised within the same listening space.

The position of the user may be comprised within a first listening space and the listening position is comprised within a second listening space.

The listening space may be represented by a plurality of audio signal content sets.

The listening position may be determined by one or more user inputs.

The means may be for adapting the spatial audio parameters of the position of the user by increasing increase the diffuseness of the audio.

The spatial audio parameters may comprise spatial metadata parameters.

The spatial audio parameters may comprise, for one or more frequency sub-bands, information indicative of;
a sound direction, and
sound directionality.

According to various, but not necessarily all, examples of the disclosure there is provided an apparatus comprising at least one processor; and at least one memory including computer program code, the at least one memory and the computer program code configured to, with the at least one processor, cause the apparatus at least to perform:
obtaining spatial audio parameters for a position of a user;
obtaining spatial audio parameters for a listening position, different to the position of the user;
rendering the spatial audio for the position of the user;
rendering the spatial audio for the listening position;
mapping the spatial audio parameters for the listening position into a zone that corresponds to the position of the user; and
merging the spatial audio for the position of the user with the spatial audio for the listening position to enable the spatial audio for the position of the user to be played back simultaneously with the spatial audio for the listening position.

According to various, but not necessarily all, examples of the disclosure there is provided an electronic device comprising an apparatus described herein wherein the electronic device is at least one of: a telephone, a camera, a computing device, a teleconferencing apparatus.

According to various, but not necessarily all, examples of the disclosure there is provided a method for generating spatial audio output, the method comprising:
obtaining spatial audio parameters for a position of a user;
obtaining spatial audio parameters for a listening position, different to the position of the user;
rendering the spatial audio for the position of the user;
rendering the spatial audio for the listening position;
mapping the spatial audio parameters for the listening position into a zone that corresponds to the position of the user; and
merging the spatial audio for the position of the user with the spatial audio for the listening position to enable the spatial audio for the position of the user to be played back simultaneously with the spatial audio for the listening position.

According to various, but not necessarily all, examples of the disclosure there is provided a computer program comprising computer program instructions that, when executed by processing circuitry, cause:
obtaining spatial audio parameters for a position of a user;
obtaining spatial audio parameters for a listening position, different to the position of the user;
rendering the spatial audio for the position of the user;
rendering the spatial audio for the listening position;
mapping the spatial audio parameters for the listening position into a zone that corresponds to the position of the user; and
merging the spatial audio for the position of the user with the spatial audio for the listening position to enable the spatial audio for the position of the user to be played back simultaneously with the spatial audio for the listening position.

### BRIEF DESCRIPTION

Some examples will now be described with reference to the accompanying drawings in which:

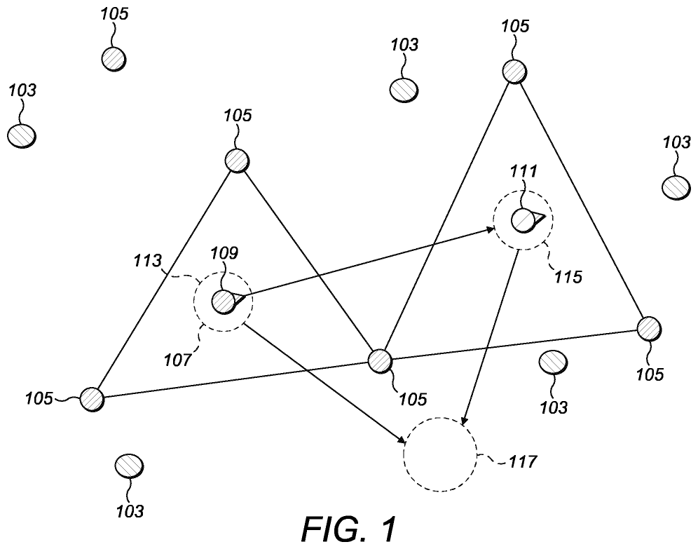

FIG. 1 shows an example listening space;

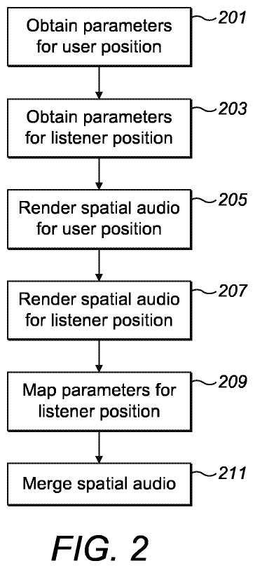

FIG. 2 shows another example method;

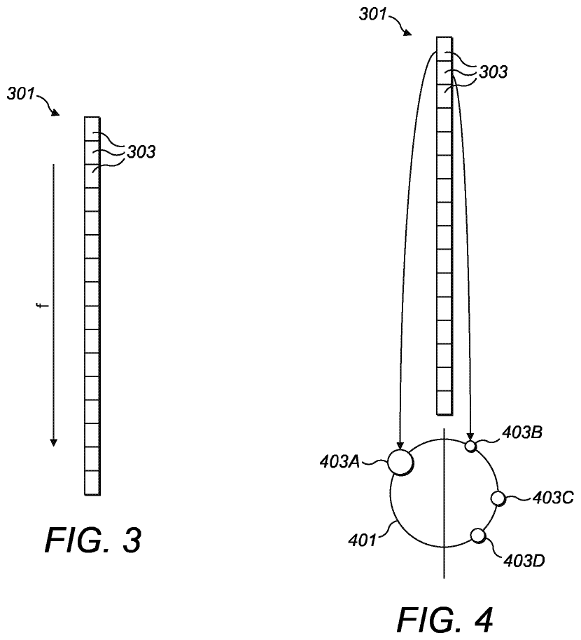

FIG. 3 schematically shows spatial audio parameters;

FIG. 4 schematically shows mappings of spatial audio parameters;

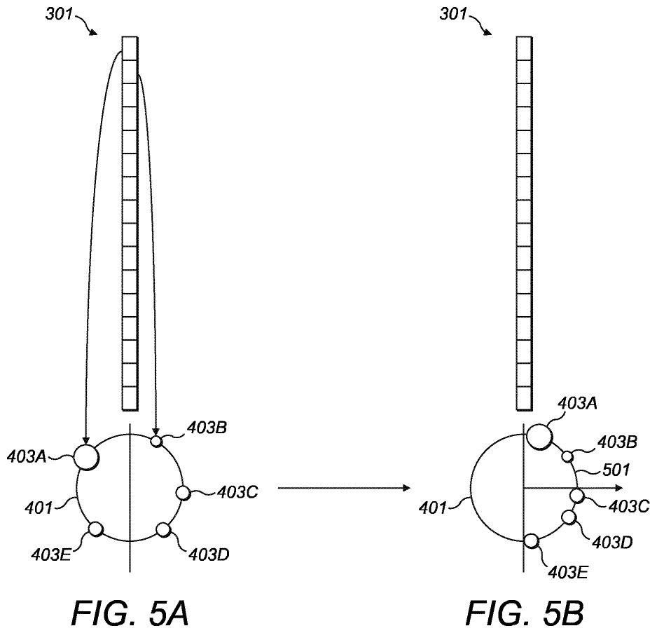

FIGS. 5A and 5B schematically show a remapping of spatial audio parameters;

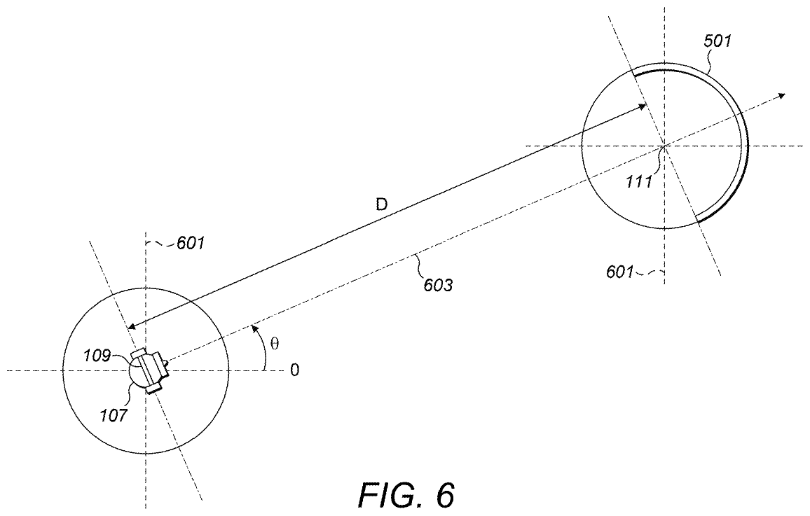

FIG. 6 schematically shows a position of a user and mapped spatial audio parameters;

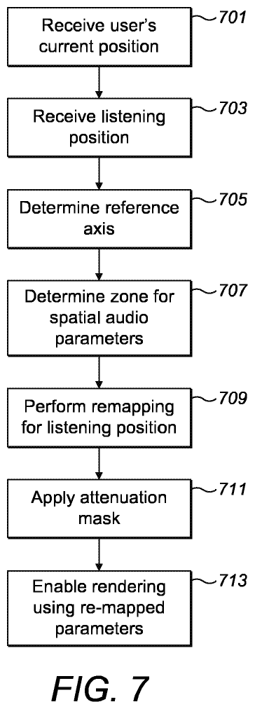

FIG. 7 shows another method;

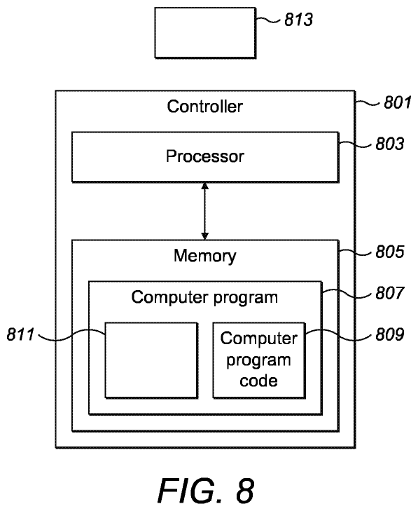

FIG. 8 shows an apparatus; and

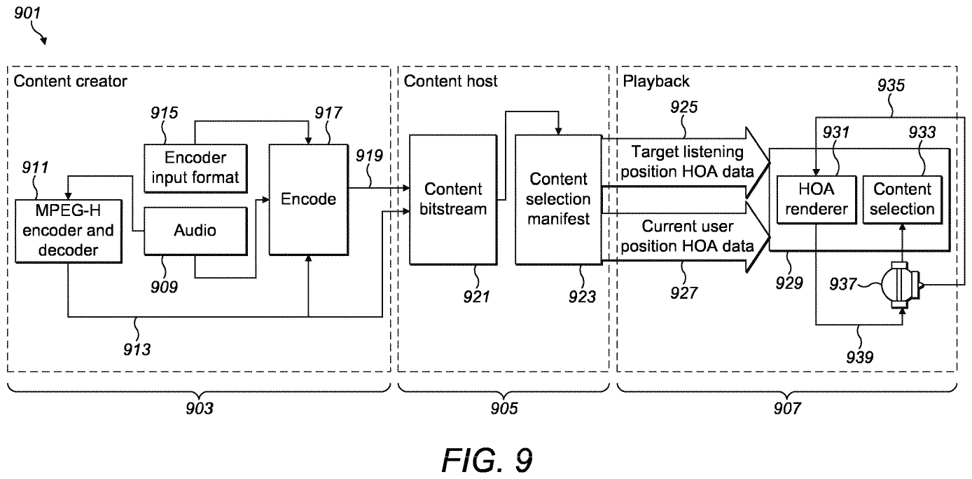

FIG. 9 shows a system.

### DETAILED DESCRIPTION

Examples of the disclosure can be used to generate spatial audio in situations where there are a plurality of sound sources in a large listening space or in which a plurality of sources can be distributed within a plurality of different listening spaces. Examples of the disclosure can enable a user to listen to sources in a listening position different to the current position of the user. This could enable the user to hear sound sources that are far away and/or located in a different listening space.

FIG. 1 shows an example listening space 101. The listening space 101 can be constrained or unconstrained. In a constrained listening space 101 the boundaries of the listening space 101 are predefined whereas in an unconstrained listening space 101 the boundaries are not predefined.

The listening space 101 is a volume that represents an audio scene. In the example of FIG. 1 a user 107 is shown at a first position 109 within the listening space 101. The user 107 can be free to move within the listening space 101 so that the user 107 can be in different positions.

The listening space 101 therefore comprises a plurality of listening positions that can be used to experience the audio scene.

The user's 107 perception of the audio scene is dependent upon their position within the listening space 101. The user's perception of the audio scene is dependent upon their position relative to sound sources 103 within the listening space 101 and any other factors that affect the trajectory of sound from the sound source 103 to the position of the user 107.

The position 109 of the user 107 can comprise a combination of both a location and an orientation. That is a user 107 can change their position 109 by making a rotational movement, for example they might turn around or rotate their head to face towards a different direction.

A user 107 could also change position 109 by making a translational movement, for example they might move along an axis or within a plane.

In some examples the listening space 101 can be configured to enable a user 107 to move with six degrees of freedom (6DOF) within the listening space 101. This can enable the user 107 to move with three translational degrees of freedom (forwards/backwards, left/right and up/down) and three rotational degrees of freedom (yaw, pitch and roll). To enable perception of spatial audio the audio that is provided to the user 107 is dependent upon the user position 109.

The listening space 101 comprises a plurality of sound sources 103. In this example the listening space 101 comprises five sound sources 103. Other numbers of sound sources 103 could be used in other example listening spaces 101.

The sound sources 103 are distributed throughout the listening space 101. The sound sources 103 are distributed so that they are positioned at different distances and/or directions form the user 107 in the first position 109. The sound sources 103 can be positioned within the listening space 101 or be positioned outside of the listening space 101. That is, a sound source 103 does not need to be positioned within the listening space 101 to be audible within the listening space 101.

This audio scene and the listening space 101 are represented by a plurality of audio signal content sets 105. The audio signal content sets 105 can comprise sets of multi-channel audio signals or any other type of audio signals. In this example the audio signal content sets 105 comprise Higher Order Ambisonic sources. The HOA sources are audio signal sets comprising HOA signals. The HOA sources can also comprise metadata relating to the HOA signals. The metadata can comprise spatial metadata that enables spatial rendering of the HOA signals. In some examples the HOA sources could comprise different types of audio signals such as stereo signals or any other type of audio signals. Other types of audio signal content sets 105 could be used in other examples of the disclosure.

The audio signal content sets 105 can represent audio corresponding to sound sources 103 that are audible within the listening space 101. In some examples each audio signal content set 105 can represent one or more sound sources 103 that are audible within the listening space 101.

In some examples the audio signal content sets 105 can be positioned within the listening space 101. In some examples the audio signal content sets 105 need not be positioned within the listening space 101 but can be positioned so that the sound sources 103 represented by the audio signal content sets 105 are audible in the listening space 101.

The locations of the sound sources 103 do not need to be known. The audio signal content sets 105 can be used to represent the audio scene even if the location of the sound sources 103 is not known.

In examples of the disclosure a user 107 can select a listening position 111 different to the position of the user 107. The user 107 could use any suitable means to select the listening position 111. For example, the user 107 could make an input on a user interface of an electronic device or by any other suitable means. The user 107 can select the listening position 111 without changing their current position 109. The user 107 does not need to move from the first position 109 to select the listening position 111.

First spatial audio parameters 113 can be used to enable spatial audio to be rendered to the user 107 at the first position 109. In the example of FIG. 1 these spatial audio parameters 113 would be obtained by spatial interpolation of the audio signal content sets 105 that are closest to the first position 109. These audio signal content sets 105 are indicated by the triangle around the first position 109 in FIG. 1. The spatial audio parameters 113 have been represented by the dashed circle around the user 107 in FIG. 1

However, second, different spatial audio parameters 115 would be needed to enable spatial audio to be rendered for the listening position 111. In the example of FIG. 1 these spatial audio parameters 115 would be obtained by spatial interpolation of the audio signal content sets 105 that are closest to the listening position 111. These audio signal content sets 105 are indicated by the triangle around the listening position 111 in FIG. 1. The spatial audio parameters 115 have been represented by the dashed circle around the listening position 111 in FIG. 1

In order to enable a user 107 to listen to both the spatial audio for the first position 109 and the spatial audio for the second position 111 the spatial audio for the two different positions can be merged to obtain merged spatial audio 115. The example method of FIG. 2 can be used to obtain the merged spatial audio 115.

FIG. 2 shows an example method that can be used to merge spatial audio for a user position 109 and a listener position 111. The method of FIG. 2 could be implemented using an apparatus 801 as show in FIG. 8 and/or a system 901 as shown in FIG. 9 and/or any other suitable apparatus or devices.

The method comprises, at block 201, obtaining spatial audio parameters for a position 109 of the user 107. The position 109 can comprise a combination of both the location and orientation of the user 107. That is, facing in different directions without changing location would result in a change in position 109 of the user 107.

The spatial audio parameters can comprise spatial metadata parameters or any other suitable types of parameters. The spatial audio parameters can comprise any data that expresses the spatial features of the audio scenes in the listening space 101. For example, the spatial audio parameters could comprise one or more of the following: direction parameters, direct-to-total ratio parameters, diffuse-to-total ratio parameters, spatial coherence parameters (indicating coherent sound at surrounding directions), spread coherence parameters (indicating coherent sound at a spatial arc or area), direction vector values and any other suitable parameters expressing the spatial properties of the spatial sound distributions.

In some examples the spatial audio parameters can comprise information indicative of a sound direction and a sound directionality. The sound directionality can indicate how directional or non-directional/ambient the sound is. This spatial metadata could be a direction-of-arriving-sound and a direct-to-total ratio parameter. The spatial audio parameters can be provided in frequency bands. Other parameters could be used in other examples of the disclosure.

In some examples the spatial audio parameters can comprise, for one or more frequency sub-bands, information indicative of; sound direction, and sound directionality.

At block 203 the method comprises obtaining spatial audio parameters for a listening position 111. The listening position 111 can be a different position to the position 109 of the user 107. In some examples the listening position 111 could have the same orientation but a different location to the position 109 of the user 107. In other examples both the location and the orientation could be different.

The listening position 111 can be within the same listening space 101 as the position 109 of the user 109 as is shown in the example of FIG. 1. This can enable a user 107 to listen to different parts of the same listening space 101.

In other examples the listening position 111 can be located within a different listening space 101. In such examples, the position 109 of the user 107 is comprised within a first listening space 101 and the listening position 111 is comprised within a second listening space 101. In such examples, the user 107 could be using an application, such as a game or other content, that comprises a plurality of listening spaces 101 and can make a user input to select a listening position 111 in a different listening space 101 without changing their position 109. This could enable a user 107 to peep or eavesdrop into different audio scenes.

In some examples the listening position 111 can be a zoom position. That is the user 107 could make an input that enables an audio zoom or focus to a particular position within the listening space 101.

The listening position 111 can be a position within the listening space 101 in which different sounds would be audible compared to the position 109 of the user 107. For instance, the listening position 111 could comprise a location that is far away from the position 109 of the user 107. This could mean that sounds that are audible at the listening position 111 would not be audible at the position 109 of the user 107.

The spatial audio parameters that are obtained for the listening position 111 can be the same type of parameters that are obtained for the position 109 of the user 107. That is, they can comprise spatial metadata parameters such as direction parameters, direct-to-total ratio parameters, diffuse-to-total ratio parameters, spatial coherence parameters (indicating coherent sound at surrounding directions), spread coherence parameters (indicating coherent sound at a spatial arc or area), direction vector values and any other suitable parameters expressing the spatial properties of the spatial sound distributions.

At block 205 the method comprises rendering the spatial audio for the position 109 of the user 107. Any suitable process can be used to render the spatial audio for the position 109 of the user 107. The spatial audio parameters that are obtained at block 201 can be used to render the spatial audio for the position 109 of the user 107.

At block 207 the method comprises rendering the spatial audio for the listening position 111. Any suitable process can be used to render the spatial audio for the listening position 111. The spatial audio parameters that are obtained at block 203 can be used to render the spatial audio for the listening position 111. The process used to render the spatial audio for the listening position 111 can be the same as the process used to render the spatial audio for the position 109 of the user 107.

At block 209 the method comprises mapping the spatial audio parameters for the listening position 111 into a zone that corresponds to the position 109 of the user 107.

In some examples the mapping of the spatial audio parameters for the listening position 111 could comprise re-mapping the spatial audio parameters for the listening position 111 or any other suitable process. This can comprise effectively repositioning some of the spatial audio parameters so that they are located within a predetermined region as defined by the zone.

In some examples the mapping of the spatial audio parameters for the listening position 111 can comprise re-mapping the spatial audio parameters to a reduced zone. The reduced zone can comprise a smaller area than the area that the parameters would be located within before the remapping is applied.

The zone to which the spatial audio parameters are mapped can take into account the position 109 of the user 107 relative to the listening position 111. For example, if the position 109 of the user 107 and the listening position 111 are in the same listening space 101 the size of the reduced zone can be determined by the distance between the position 109 of the user 107 and the listening position 111. In such examples, the larger the distance between the position 109 of the user 107 and the listening position 111 the smaller the reduced zone will be.

In some examples the zone to which the spatial audio parameters are mapped can take into account the field of view of the user 107. For example, it can take into account the direction that the user 107 is facing and how far away the listening position is 111. This can create an angular range that defines a zone to which the spatial audio parameters can be remapped.

The orientation of the reduced zone can be determined based on the orientation of the listening position 111 relative to the direction in which the user 109 is facing.

If the listening position 111 is within a different listening space 101 to the position 109 of the user 107 then the size of the reduced zone can be determined based on other factors. In some examples the size and orientation of the reduced zone could be determined based on the relative position of the different listening space to the listening space in which the user 107 is located.

The reduced zone can be configured to reduce rendering of sounds positioned between the position 109 of the user 107 and the listening position 111. For example, if there are one or more sound sources 103 located between the user 107 and the listening position 111 then this would appear as a sound in front of the user 107 at the position 109 of the user 107 but a sound that is behind the user 107 at the listening position. To avoid this sound being included in the sounds at the listening position 111 such sound sources 109 could be attenuated or otherwise reduced.

At block 209 the method comprises merging the spatial audio for the position 109 of the user 107 with the spatial audio for the listening position 111. The merging of the spatial audio is such that it enables the spatial audio for the position 109 of the user 109 to be played back simultaneously with the spatial audio for the listening position 111. The merging of the spatial audio can be such that it enables the spatial audio for the position 109 of the user 109 to be played back in a different direction to the spatial audio for the listening position 111. This can enable the user 107 to hear both the audio for their current position 109 and the audio for the listening position 111.

The method can also comprise additional blocks or processes that are not shown in FIG. 2. For instance, in some examples the method can comprise adapting the spatial audio parameters for the listening position 101 to take into account the position 109 of the user 107 relative to the listening position.

In some examples the method could comprises adapting the spatial audio parameters of the position of the user 107. The adapting of the spatial audio parameters from the position 109 of the user 107 could comprise any modification that enables both the audio from the position 109 of the user 107 and the listening position 111 to be clearly audible to the user 107. For example, it could comprise increasing the diffuseness of the audio at the position 109 of the user 107. Increasing the diffuseness could be done by this could be done by reducing the direct to total energy, by reducing the gain or sound level in a particular direction and/or by using any other suitable process.

Examples of the disclosure provide for an improves spatial audio experience for a user 107. For instance, if a user 107 is in a large listening space 101 such as a sports arena they could choose to zoom in to a different listening position 111 to hear audio at the different position. For instance, a user could be positioned in the seats of a sports arena but might want to hear audio from the sports field. The merging of the spatial audio as described herein enables the user 107 to hear the cheers from the crowd as well as some of the audio from the sports field.

In another example a user could use examples of the disclosure to peep into, or eavesdrop into a different listening space 101. For instance, the user could be playing a game or rendering content that comprises a plurality of different listening spaces 101. A user could select a different listening space 101 to listen in to by making an appropriate user input. The examples of the disclosure could then be used to merge the spatial audio from the different listening spaces.

FIG. 3 schematically shows spatial audio parameters 301 that can be used in examples of the disclosure. The spatial audio parameters 301 can be used either for the position 109 of the user 107 or the listening position 111. The same format of the spatial audio parameters 301 can be used for both the position 109 of the user 107 and the listening position 111.

The spatial audio parameters 301 can be determined for an audio signal content set 105 that coincides with the position 109 of the user 107 or the listening position 111. If there is not an audio signal content set 105 that coincides with the position 109 of the user 107 or the listening position 111 then the spatial audio parameters 301 can be determined by interpolation from audio signal content sets 105 that are near to the position 109 of the user 107 or the listening position 111.

In the example of FIG. 3 the spatial audio parameters 301 comprise a plurality of different frequency bands 303. The different frequency bands 303 are represented by the boxes in FIG. 3. In the example of FIG. 3 the spatial audio parameters 301 comprise sixteen different frequency bands 303. In other examples the spatial audio parameters 301 could comprise any suitable number of frequency bands 303.

In the example of FIG. 3 each of the frequency bands 303 are the same size. In other examples different frequency bands 303 could have different sizes. For example, lower frequency bands could have a larger band size than the higher frequency ranges.

The spatial audio parameters 301 can comprise any suitable information for each of the frequency bands 303. In some examples the spatial audio parameters 301 can comprise information indicative of an azimuth angle, information indicative of an angle of elevation, information indicative of a direct to total energy ratio, information indicative of total energy and/or any other suitable information of combination of information.

Any suitable means and processes can be used to determine the spatial audio parameters 301.

In some examples the spatial audio parameters 301 can be described using the following syntax or any other suitable syntax.

```
aligned(8) 6DOFSpatialMetadataStruct( ){
  unsigned int(8) num_frequency_bands;
  for (i=0; i<num_frequency_bands;i++){
    signed int(16) spatial_meta_azimuth;
    signed int(16) spatial_meta_elevation;
    unsigned int(16) direct_to_total_energy_ratio;
    unsigned int(32) energy;
  }
}
```

FIG. 4 schematically shows a mapping of spatial audio parameters 301. The spatial audio parameters 301 can be as shown in FIG. 3. Other types of spatial audio parameters 301 could be used in other examples of the disclosure. The spatial audio parameters 301 could be the spatial audio parameters 301 of the position 109 of the user 107 or of the listening position 111.

In this schematic example the spatial audio parameters 301 are mapped to a circle 401. The circle 401 is centered on a position which could be the position 109 of the user 107 or the listening position 111 or any other suitable position.

A plurality of smaller circles 403 are shown mapped onto the larger circle 401. The smaller circles 403 represent the dominant frequency for different frequency bands 303. The smaller circles 403 are mapped to a position of the larger circle 401 that is based on the direction of the dominant frequency.

In the example four smaller circles 403A, 403B, 403C and 403D are shown. these represent the dominant frequency for four different frequency bands 303. There would be a smaller circle 403 for each of the frequency bands 303 in the spatial audio parameters 301 however only four are shown for clarity.

In the example of FIG. 4 the smaller circles 403A, 403B, 403C and 403D have different sizes. The different sizes indicate the different total energy within each of the frequency bands 303. The different smaller circles could also have different levels of diffuseness.

In examples of the disclosure, it is likely that the smaller circles 403A, 403B, 403C and 403D representing the dominant frequency would be, at least partially, overlapping. However, in FIG. 4 they have been shown separately for clarity.

FIGS. 5A and 5B schematically show a remapping of spatial audio parameters 301. The spatial audio parameters 301 in this case would be the spatial audio parameters 301 of the listening position 111.

FIG. 5A shows how the spatial audio parameters 301 would be mapped for a scenario in which a user was actually located at the listening position 111. In this example the smaller circles 403 are located all around the circle 401. That is, they are located on both the left-hand side and right-hand side of the circle 401.

FIG. 5B shows how the spatial audio parameters 301 would be mapped for the listening position 111 where the user is located to the left of the listening position 111. In this circumstance the spatial audio parameters 301 are remapped to a zone 501 corresponding to the position 109 of the user 107. The zone 501 comprises a region of the circle 401. The location of the zone 501 can be determined by the field of view of the user 107. For instance, in this case the user 107 is position to the left-hand side of the listening position 111. In this case the spatial audio parameters 301 are remapped to a zone on the right-hand side of the circle 401. This leaves the left-hand side of the circle 401 clear.

In the example of FIG. 5B the zone 501 comprise half of the circle 401. Other angular ranges for the zone 501 could be used in other examples. The angular range of the zone 501 can be determined by the distance between the listening position 111 and the position 109 of the user 107. For instance, if the user 107 is further away then the angular range of the zone 501 would be smaller.

In some examples a remapping function can be used to remap the spatial audio parameters 301 to the zone 501.

An example remapping function could be:

$${FOV}_{remapped} = ( {FOV}_{original} ) / K ;$$

Where K is a constant proportional to the distance between the position 109 of the user 107 and the listening position 111.

$$K = m * D ;$$

where D is the distance between the position 109 of the user 107 and the listening position 111 and m is a constant. m can be a content creator specified object or it can be a multiplier derived via any other suitable method.

FOV can be the field of view. This can be the angular range of the circle 401 around the listening position 111 to which spatial audio parameters can be mapped. The original field of view can be the original positions of the spatial audio parameters. The remapped field of view can comprise the zone to which the spatial audio parameters are re-mapped.

In some examples the remapping function can be used to modify only some of the spatial audio parameters. For instance, the remapping function can be used to modify the azimuth parameters and the elevation parameters based on the relative locations of the listening position 111 and the position 109 of the user 107. For example. spatial_meta_azimuth and spatial_meta_elevation values can be adjusted.

A reference axis for the remapping can be selected based on the angular direction between the listening position 111 and the position 109 of the user 107. For example the reference direction could be an axis that connects the listening position 111 and the position 109 of the user 107.

In the example of FIGS. 5A ad 5B the spatial audio parameters have been remapped. That is, they have been repositioned. In some examples the spatial audio parameters could already be position within the appropriate zone 501. In such examples the process odes not need to remap the spatial audio parameters but just ensure that the mapping is in the correct zone 501.

FIG. 6 schematically shows a position 109 of a user 107 and mapped spatial audio parameters for a listening position 111.

In this example the position 109 of the user 107 and the listening position are within the same listening space 101. This could be the listening space 101 as shown in FIG. 1 or any other suitable listening space.

The listening position 111 is located at a distance D from the position 109 of the user 107 and at a bearing of θ relative to a refence coordinate system 601. An axis 603 connects the listening position 111 and the position 109 of the user 107. The axis 603 can be used as a reference axis for a remapping function.

In this example the zone 501 of the listening position 111 to which the spatial audio parameters are to be mapped is indicted by the thick line. This zone 501 comprises half of the circle around the listening position 111. Other angular ranges for the zone 501 could be used in other examples of the disclosure.

The angular position of the zone 501 is determined based on the refence axis 603. In this example, the angular position of the zone 501 is rotated so that it is aligned with the bearing θ.

FIG. 7 shows another example method that can be used to merge spatial audio for a user position 109 and a listener position 111. The method of FIG. 7 could be implemented using an apparatus 801 as show in FIG. 8 and/or a system 901 as shown in FIG. 9 and/or any other suitable apparatus or devices.

At block 701 the method comprises receiving information indicative of the current position 109 of the user 107. In some examples the current position 109 of the user 107 could be a real-world position or based on a real-world position. In such examples the information indicative of the current position 109 of the user 107 could be received from any suitable positioning system. In some examples the current position 109 of the user 107 could be the position within a virtual world, for example the position within a mediated reality environment and/or a gaming environment. In such examples the information indicative of the current position 109 of the user 107 could be received from the provider of of the virtual world or from any other suitable source.

The position 109 of the user 107 can comprise the location of the user 107. For example, it can comprise the X, Y and Z coordinates within a cartesian coordinate system. In some examples the position 109 of the user 107 can comprise the orientation of the user 107. This can indicate the direction in which the user 109 is facing. This can be given as angles of yaw, pitch and roll (φ₁, θ₁, ψ₁) in any suitable coordinate system.

At block 703 the method comprises receiving information indicative of the listening position 111. A user 107 could select a listening position 111 by making an appropriate user input via a user interface or any other suitable means. For example, they could select a listening position 111 on a representation of a listening space 101. This could be categorized as “zoom in” input.

The user interface can then provide the following information to the apparatus performing the method indicative of the listening position 111 and the audio signal content sets 105 at the listening position.

```
aligned(8) 6DOFZoomInteractionInputStruct( ){
  signed int(32) target_zoomin_pos_x;//X₂
  signed int(32) target_zoomin_pos_y;//Y₂
  signed int(32) target_zoomin_pos_z;//Z₂
  signed int(16) target_zoomin_rot_yaw;//φ₁
  signed int(16) target_zoomin_rot_pitch;//θ₁
  signed int(16) target_zoomin_rot_roll;//ψ₁
}
aligned(8) HOASourcePositionStruct( ){
  signed int(32) hoa_source_pos_x;//X₁
  signed int(32) hoa_source_pos_y;//Y₁
  signed int(32) hoa_source_pos_z;//Z₁
  signed int(16) hoa_source_rot_yaw;
  signed int(16) hoa_source_rot_pitch;
  signed int(16) hoa_source_rot_roll;
}
```

The values of hoa_source_pos_x, hoa_source_pos_y, hoa_source_pos_z define the location of the listening position 111 in any suitable coordinate system. Any suitable units can be used to define the location. The hoa_source_rot_yaw and hoa_source_rot_roll can be any angle between −180° to +180°. The hoa_source_rot_pitch can be any angle between −90° to +90°. Any suitable units or step sizes can be used for the angles.

At block 705 a reference axis 603 is determined. The information received at blocks 701 and 703 relating to the position 109 of the user 107 and the listening position 111 can be used to determine the reference axis 603. The reference axis 603 can connect the listening position 111 and the position 109 of the user 107. The reference axis 603 could be as shown in FIG. 6 or could be any other suitable axis.

At block 707 the zone 501 is determined. The zone 501 is the region to which the spatial audio parameters of the listening space 111 are to be mapped. The zone 501 corresponds to the position of the user 107 such that the zone 501 can be determined based on the relative positions of the position 109 of the user 107 and the listening position 111. For an arrangement as shown in FIG. 6 the zone 501 can be determined based on the distance D between the position 109 of the user 107 and the listening position 111 and/or the bearing θ between the position 109 of the user 107 and the listening position 111. The reference axis 603 that is determined at block 705 can be used to determine the angular orientation of the zone 501.

At block 709 the spatial audio parameters for the listening position are remapped to the zone 501. Any suitable remapping function can be used to remap the spatial audio parameters. The remapping can effectively reposition the spatial audio parameters so that they are positioned within the zone 501.

The remapping can move the spatial audio parameters into a defined angular range. The angular range can be defined by the distance between the position 109 of the user 107 and the listening position 111. The spatial audio parameters can be rotated so that the zone 501 is aligned with the bearing θ between the position 109 of the user 107 and the listening position 111. The rotation can be defined by the reference axis 603 so that the zone 501 is aligned with the reference axis 603.

At block 711 an attenuation mask can be applied. The attenuation mask can comprise any means that can be used to filter out unwanted sounds between the user 107 and the listening position 111. For example, if there are one or more sound sources 103 located between the user 107 and the listening position 111 then this would appear as a sound in front of the user 107 at the position 109 of the user 107 but a sound that is behind the user 107 at the listening position. To avoid this sound being included in the sounds at the listening position 111 such sound sources 109 could be attenuated using an attenuation mask or otherwise reduced.

At block 713 the method comprises enable rendering of the audio at the listening position 111 using the remapped spatial audio parameters. Any suitable means can be used for this rendering. The rendered audio for the listening position 111 can then be merged with the rendered audio for the position 109 of the user to enable the spatial audio for the position of the user to be played back simultaneously with the spatial audio for the listening position. The merging can comprise adding the remapped audio from the listening position 111 to the current audio for the position 109 of the user 107.

In the example of FIG. 7 the remapping has been performed only for the spatial audio parameters of the listening position 111. This can enable audio visual alignment to be maintained for sound sources 103 that are closer to the user 107. In some examples the remapping could be performed both for the spatial audio parameters of the listening position 111 and the spatial audio parameters of the position 109 of the user 107. This can enable the audio for the different positions to be mapped to different regions around the user 107. This can enable the user 107 to distinguish between audio from the position 109 of the user 107 and audio from the listening position 111 based on the relative positions of the audio.

In the example of FIG. 7 the position 109 of the user 107 and the listening position 111 can be in the same listening space 101 so that a reference axis 603 can be defined based on their relative positions. In other examples the listening position 111 could be within a different listening space 101 to the user 107. For examples a plurality of listening spaces 101 can be available a user can select a listening position within any of a plurality of the different listening spaces 101. This can enable a user 107 to peep into, or eavesdrop into, a different listening space 101.

In order to enable examples comprising a plurality of different listening spaces 101 relative positions between the respective listening spaces 101 can be defined. In some examples audio content sets 105 for each listening space 101 can be generated and then relative positions between audio content sets 105 can be defined. In some examples a plurality of audio content sets 105 can be provided within the different listening spaces 111.

In an example implementation, the position is for each of the listening spaces can be defined using the following cartesian coordinate system:

```
  aligned(8) AudioSceneLayout{
        unsigned int(8) numAudioScenes;
        for(i=0;i<numAudioScenes;i++){
          unsigned int(8) audio_scene_id;
          unsigned int(32) positionX;
          unsigned int(32) positionY;
          signed int(32) positionZ;
          signed int(32) Yaw;
          signed int(32) Pitch;
          signed int(32) Roll;
        }
  }
  aligned(8) HOAGroupLayout{
        unsigned int(8) numHOAGroups;
        for(1=0;i<HOAGroups;i++){
          unsigned int(8) hoa_group_id;
          unsigned int(32) positionX;
          unsigned int(32) positionY;
          signed int(32) positionZ;
          signed int(32) Yaw;
          signed int(32) Pitch;
          signed int(32) Roll;
        }
  }
aligned(8) AudioSceneLayout{//Audio scene with multiple HOA groups
  unsigned int(8) numAudioScenes;
  for(i=0;i<numAudioScenes;i++){
    unsigned int(8) audio_scene_id;
    unsigned int(8) numHOAGroups;
    for(i=0;i<HOAGroups;i++){
      unsigned int(8) hoa_group_id;
      unsigned int(32) positionX;
      unsigned int(32) positionY;
      signed int(32) positionZ;
      signed int(32) Yaw;
      signed int(32) Pitch;
      signed int(32) Roll;
    }
  }
}
```

This information can be used by an apparatus or other suitable device to determine the listening space 111 that a user 107 has selected to peep into from their current position.

In different implementation the different listening spaces 111 can be logically positioned by a content creator. In such example the user interface that enables a user 107 to select a listening position 111 can also be configured to select the position and orientation values based on those logical positions. The logical positions can be transformed to cartesian coordinates or any other suitable coordinate system.

In some examples a content creator can select appropriate distances and positions for the respective listening positions 111. These distances and positions can be used to generate an effect of distance and creating a zooming experience, For example, a greater distance can be used to give an impression that the listening position 111 is further away in such examples the further away the listening position 111 is from the user position the narrower the zone that is used for the spatial audio parameters.

FIG. 8 schematically shows an example apparatus 801 that could be used in some examples of the disclosure. In the example of FIG. 8 the apparatus 801 comprises at least one processor 803 and at least one memory 805. It is to be appreciated that the apparatus 801 could comprise additional components that are not shown in FIG. 8.

The apparatus 801 can be configured to generate spatial audio outputs based on examples of this disclosure.

In the example of FIG. 8 the implementation of the apparatus 801 can be implemented as processing circuitry. In some examples the apparatus 801 can be implemented in hardware alone, have certain aspects in software including firmware alone or can be a combination of hardware and software (including firmware).

As illustrated in FIG. 8 the apparatus 801 can be implemented using instructions that enable hardware functionality, for example, by using executable instructions of a computer program 807 in a general-purpose or special-purpose processor 803 that can be stored on a computer readable storage medium (disk, memory etc.) to be executed by such a processor 803.

The processor 803 is configured to read from and write to the memory 805. The processor 803 can also comprise an output interface via which data and/or commands are output by the processor 803 and an input interface via which data and/or commands are input to the processor 803.

The memory 805 is configured to store a computer program 807 comprising computer program instructions (computer program code 809) that controls the operation of the apparatus 801 when loaded into the processor 803. The computer program instructions, of the computer program 807, provide the logic and routines that enables the apparatus 801 to perform the methods illustrated in FIGS. 2 and 7. The processor 803 by reading the memory 805 is able to load and execute the computer program 807.

The apparatus 801 therefore comprises: at least one processor 803; and at least one memory 805 including computer program code 809, the at least one memory 805 and the computer program code 809 configured to, with the at least one processor 803, cause the apparatus 801 at least to perform:
obtaining spatial audio parameters for a position of a user;
obtaining spatial audio parameters for a listening position, different to the position of the user;
rendering the spatial audio for the position of the user;
rendering the spatial audio for the listening position;
mapping the spatial audio parameters for the listening position into a zone that corresponds to the position of the user; and
merging the spatial audio for the position of the user with the spatial audio for the listening position to enable the spatial audio for the position of the user to be played back simultaneously with the spatial audio for the listening position.

As illustrated in FIG. 8 the computer program 807 can arrive at the apparatus 801 via any suitable delivery mechanism 813. The delivery mechanism 813 can be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 807. The delivery mechanism can be a signal configured to reliably transfer the computer program 807. The apparatus 801 can propagate or transmit the computer program 807 as a computer data signal. In some examples the computer program 807 can be transmitted to the apparatus 801 using a wireless protocol such as Bluetooth, Bluetooth Low Energy, Bluetooth Smart, 6LoWPan (IPv6 over low power personal area networks) ZigBee, ANT+, near field communication (NFC), Radio frequency identification, wireless local area network (wireless LAN) or any other suitable protocol.

The computer program 807 comprises computer program instructions for causing an apparatus 807 to perform at least the following:
obtaining spatial audio parameters for a position of a user;
obtaining spatial audio parameters for a listening position, different to the position of the user;
rendering the spatial audio for the position of the user;
rendering the spatial audio for the listening position;
mapping the spatial audio parameters for the listening position into a zone that corresponds to the position of the user; and
merging the spatial audio for the position of the user with the spatial audio for the listening position to enable the spatial audio for the position of the user to be played back simultaneously with the spatial audio for the listening position.

The computer program instructions can be comprised in a computer program 807, a non-transitory computer readable medium, a computer program product, a machine readable medium. In some but not necessarily all examples, the computer program instructions can be distributed over more than one computer program 807.

Although the memory 805 is illustrated as a single component/circuitry it can be implemented as one or more separate components/circuitry some or all of which can be integrated/removable and/or can provide permanent/semi-permanent/dynamic/cached storage.

Although the processor 803 is illustrated as a single component/circuitry it can be implemented as one or more separate components/circuitry some or all of which can be integrated/removable. The processor 803 can be a single core or multi-core processor.

References to “computer-readable storage medium”, “computer program product”, “tangibly embodied computer program” etc. or a “controller”, “computer”, “processor” etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term “circuitry” can refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions and
(c) hardware circuit(s) and or processor(s), such as a microprocessor(s) or a portion of a microprocessor(s), that requires software (e.g. firmware) for operation, but the software might not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in the FIGS. 2 and 7 can represent steps in a method and/or sections of code in the computer program 807. The illustration of a particular order to the blocks does not necessarily imply that there is a required or preferred order for the blocks and the order and arrangement of the block can be varied. Furthermore, it can be possible for some blocks to be omitted.

FIG. 9 shows an example system 901 that could be used to implement some examples of the disclosure. The system 901 comprises one or more content creator devices 903, one or more content hosting devices 905 and one or more playback devices 907. Other types of devices could be comprised within the system 901 in other examples.

The content creator device 903 comprises an audio module 909. The audio module 909 can comprise any means configured to generate spatial audio. For example, the audio module 909 can comprise a plurality of spatially distributed microphones or any other suitable means.

The audio that is generated by the audio module can be provided to an MPEG-H Encoder/decoder module 911. The MPEG-H Encoder/decoder module 911 encodes the audio into the MPEG-H format. Other types of audio format could be used in other examples of the disclosure.

The MPEG-H Encoder/decoder module 911 provides MPEG-H encoded/decoded audio 913 as an output. The MPEG-H encoded/decoded audio 913 can be provided as an input to an encoder module 917 within the content creator device 903. The MPEG-H encoded/decoded audio 913 can also be provided as an input to other parts of the system 901. In the example of FIG. 9 the MPEG-H encoded/decoded audio 913 is provided as an input to the content host device 905.

The content creator device 903 also comprises an encoder module 917. The encoder module 917 is configured to receive audio from the audio module 909. In this example the encoder module 917 can receive raw audio data from the audio module 909. The encoder module 917 also receives an input comprises an encoder input format 915. The encoder input format 915 comprises information relating to the listening space 101 and the format that is to be used by the encoder module 917.

The encoder module 917 also receives the MPEG-H encoded/decoded audio 913 as an input.

The encoder module 917 uses the raw audio data from the audio module 909, the MPEG-H encoded/decoded audio 913 and the encoder input format 915 to generate the spatial audio parameters or metadata to enable spatial rendering of the audio. In some examples the encoder module 917 can be configured to generate the spatial audio parameters so as to enable spatial audio rendering that allows for six degrees of freedom of movement for the user 107. This rendering can comprise audio signal content sets 105 such as HOA sources or any other suitable type of spatial audio parameters.

The encoder module 917 provides spatial audio parameters 919 as an output. The spatial audio parameters 919 can be provided to the content host device 905.

The content host device 905 combines the spatial audio parameters 919 with the MPEG-H encoded/decoded audio 913 to generate the content bitstream 921.

The content host device 905 is configured to generate a content selection manifest 923. The content selection manifest 923 enables a user 107 of a playback device 907 to select from the available content. For example, it can enable a user 107 to select a listening position 111 and the content corresponding to the listening position 111. The manifest can also enable the content corresponding to the current position 109 of the user 107 to be selected.

The playback device 907 is configured to retrieve the audio content 927 for the current position 109 of the user 107 and also the audio content 925 for the target listening position 111. The target listening position 111 can be defined by a user input or any other suitable means.

The playback device 907 can comprise a content selection module 933. The content selection module can receive a user input 937. The user input 937 can be made using any suitable user interface or user input device. The user input can enable the selection of a listening position 111. In response to the selection of the listening position 111 the content selection module 933 can enable the audio content 925 for the target listening position 111 to be selected.

The content selection module 933 can be provided within a media player module 929. The media player module 929 can also be configured to receive an input 935 indicative of the position 109 of the user 107. The input 935 indicative of the position 109 of the user 107 can be generated from any suitable positioning means. The positioning means can be provided in a head set worn by the user 107 or in any other suitable part of the system 901.

The audio content 927 for the current position 109 of the user 107 and the audio content 925 for the target listening position 111 can be provided to the media player module 929 within the playback device 907. In this example the media player module 929 comprises a HOA renderer module 931. The HOA renderer module 931 can be configured to render the spatial audio for the position 109 of the user and also the spatial audio for the listening position 111. The HOA renderer 931 can also be configured to remap spatial audio for the listening position 111 according to examples of the disclosure. The HOA renderer module 931 can also be configured to merge the spatial audio for the position 109 of the user 107 with the spatial audio for the listening position 111 to enable the spatial audio for the position 109 of the user 107 to be played back simultaneously with the spatial audio for the listening position 111.

The HOA renderer module 931 provides an audio output 939 to the user device. The user device could be a headset or any other device that can enable an audio signal to be converted to an audible sound signal.

In the example of FIG. 9 a HOA renderer is used. Other types of content and rendering could be used in other examples of the disclosure.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/We claim:

1. An apparatus, comprising:
at least one processor; and
at least one memory storing instructions that, when executed with the at least one processor, cause the apparatus at least to:
obtain spatial audio parameters for a position of a user;
obtain spatial audio parameters for a listening position, different to the position of the user;
render the spatial audio for the position of the user;
render the spatial audio for the listening position;
map the spatial audio parameters for the listening position into a zone that corresponds to the position of the user; and
merge the spatial audio for the position of the user with the spatial audio for the listening position to enable the spatial audio for the position of the user to be played back simultaneously with the spatial audio for the listening position.

2. An apparatus as claimed in claim 1, wherein the listening position comprises a zoom position.

3. An apparatus as claimed in claim 2, wherein the instructions, when executed with the at least one processor, cause the apparatus to adapt the spatial audio parameters for the zoom position to take into account the position of the user relative to the zoom position.

4. An apparatus as claimed in claim 1, wherein the instructions, when executed with the at least one processor, cause the apparatus to re-map the spatial audio parameters to a reduced zone to take into account the position of the user relative to the listening position.

5. An apparatus as claimed in claim 4, wherein the instructions, when executed with the at least one processor, determine a size of the reduced zone with a distance between the position of the user and the listening position.

6. An apparatus as claimed in claim 4, wherein the reduced zone is configured to reduce rendering of sounds positioned between the position of the user and the listening position.

7. An apparatus as claimed in claim 4, wherein the instructions, when executed with the at least one processor, determine an angular position of the reduced zone based on an axis connecting the listening position and the position of the user.

8. An apparatus as claimed in claim 1, wherein the position of the user and the zoom position are comprised within the same listening space.

9. An apparatus as claimed in claim 1, wherein the position of the user is comprised within a first listening space and the listening position is comprised within a second listening space.

10. An apparatus as claimed in claim 1, wherein a listening space is represented with a plurality of audio signal content sets.

11. An apparatus as claimed in claim 1, wherein the listening position is determined with one or more user inputs.

12. An apparatus as claimed in claim 1, wherein the instructions, when executed with the at least one processor, cause the apparatus to adapt the spatial audio parameters of the position of the user with increasing diffuseness of the audio.

13. An apparatus as claimed in claim 1, wherein the spatial audio parameters comprise at least one of:
spatial metadata parameters; or
for one or more frequency sub-bands, information indicative of:
a sound direction, and
sound directionality.

14-15. (canceled)

16. A method for generating spatial audio output, the method comprising:
obtaining spatial audio parameters for a position of a user;
obtaining spatial audio parameters for a listening position, different to the position of the user;
rendering the spatial audio for the position of the user;
rendering the spatial audio for the listening position;
mapping the spatial audio parameters for the listening position into a zone that corresponds to the position of the user; and
merging the spatial audio for the position of the user with the spatial audio for the listening position to enable the spatial audio for the position of the user to be played back simultaneously with the spatial audio for the listening position.

17. A method as claimed in claim 16, wherein the listening position comprises a zoom position.

18. A method as claimed in claim 17, wherein the method comprises adapting the spatial audio parameters for the zoom position to take into account the position of the user relative to the zoom position.

19. A non-transitory program storage device readable with an apparatus, tangibly embodying a program of instructions executable with the apparatus for performing operations comprising:
obtaining spatial audio parameters for a position of a user;
obtaining spatial audio parameters for a listening position, different to the position of the user;
rendering the spatial audio for the position of the user;
rendering the spatial audio for the listening position;
mapping the spatial audio parameters for the listening position into a zone that corresponds to the position of the user; and
merging the spatial audio for the position of the user with the spatial audio for the listening position to enable the spatial audio for the position of the user to be played back simultaneously with the spatial audio for the listening position.

20-21. (canceled)

22. A method as claimed in claim 16, wherein the method comprises re-mapping the spatial audio parameters to a reduced zone to take into account the position of the user relative to the listening position.

23. A method as claimed in claim 16, wherein the method comprises adapting the spatial audio parameters of the position of the user with increasing diffuseness of the audio.

24. A method as claimed in claim 16, wherein the spatial audio parameters comprise at least one of:
spatial metadata parameters; or
for one or more frequency sub-bands, information indicative of at least one of:
a sound direction, or
sound directionality.
